(19) United States
(12) Patent Application Publication
(10) Pub. No.: US 2019/0053981 A1
(43) Pub. Date: Feb. 21, 2019

(54) TEMPERATURE THRESHOLDING IN DRUG DISPENSING DEVICES

(71) Applicant: QUALCOMM Incorporated, San Diego, CA (US)

(72) Inventors: Brian NIZNIK, San Diego, CA (US); Robert GANTON, San Diego, CA (US); Paul Robert HOFFMAN, San Diego, CA (US)

(21) Appl. No.: 16/104,042

(22) Filed: Aug. 16, 2018

Related U.S. Application Data
(60) Provisional application No. 62/547,097, filed on Aug. 17, 2017.

(51) Int. Cl. A61J 1/18; G08B 21/18

(52) U.S. Cl. CPC A61J 1/18; G08B 21/182; A61J 2205/20; A61J 2205/70; A61J 2200/72

(57) ABSTRACT

Techniques are disclosed for providing a drug-dispensing device that tracks temperatures to which a drug stored therein is exposed, further providing means for indicating to a user that the drug has been exposed to temperatures outside a suitable temperature range and/or preventing the drug from being dispensed in such cases. According to some embodiments, an electrochromic element may be used to indicate the drug has been exposed to temperatures outside the suitable temperature range.

### RELATED APPLICATIONS

This application claims the benefit of U.S. Provisional Application No. 62/547,097, filed Aug. 17, 2017, entitled “TEMPERATURE THRESHOLDING IN DRUG DISPENSING DEVICES”, which is assigned to the assignee hereof, and incorporated herein in its entirety by reference.

### BACKGROUND

### Background Field

The subject matter disclosed herein relates to monitoring temperature-sensitive materials, and more particularly to techniques for monitoring the temperature of a liquid or gel drug stored by a drug-dispensing device.

### Relevant Background

In the field of drug administration, ensuring the drug is administered properly is of primary importance. This may be especially true in situations where a drug is self-administered by the patient (rather than by a healthcare professional). Because various drugs may be temperature sensitive, one aspect of proper drug administration is ensuring that the drug is stored within a suitable temperature range. Otherwise, if the drug is exposed to temperatures outside the suitable temperature range, the drug may lose its effectiveness. Problematically, however, traditional means of storing drugs typically do not track temperatures to which the drug is exposed, much less indicate to a user (e.g., a patient that self-administers the drug) whether the drug has been exposed to temperatures outside a suitable temperature range.

### SUMMARY

Embodiments disclosed herein provide for a drug-dispensing device that tracks temperatures to which a drug stored therein is exposed, further providing means for indicating to a user that the drug has been exposed to temperatures outside a suitable temperature range and/or preventing the drug from being dispensed in such cases. According to some embodiments, an electrochromic element may be used to indicate the drug has been exposed to temperatures outside the suitable temperature range.

An example drug-dispensing device, according to the disclosure, comprises one or more temperature sensors and a processor communicatively coupled with the one or more temperature sensors. The processor is configured to obtain temperature information from the one or more temperature sensors, determine, based at least in part on the temperature information, that the one or more temperature sensors have been exposed to temperatures exceeding a first set of thresholds, and responsive to determining that the one or more temperature sensors have been exposed to temperatures exceeding the first set of thresholds, generate an indication that the one or more temperature sensors have been exposed to temperatures exceeding the first set of thresholds.

Embodiments of the drug-dispensing device may comprise one or more of the following features. The one or more temperature sensors may be configured to take one or more temperature measurements, and the temperature information may comprise the one or more temperature measurements. The processor may be further configured to determine, using the one or more temperature measurements and one or more previous temperature measurements, a length of time for which the one or more temperature sensors have been exposed to temperatures exceeding the first set of thresholds. The processor may be further configured to compare the length of time for which the one or more temperature sensors have been exposed to temperatures exceeding the first set of thresholds with a time threshold and determine that the length of time for which the one or more temperature sensors have been exposed to temperatures exceeding the first set of thresholds has exceeded the time threshold. The processor may be configured to generate the indication that the one or more temperature sensors have been exposed to temperatures exceeding the first set of thresholds additionally responsive to determining that the length of time for which the one or more temperature sensors have been exposed to temperatures exceeding the first set of thresholds has exceeded the time threshold. The one or more temperature sensors may be configured to undergo a change in one or more electrical characteristics when exposed to temperatures exceeding the first set of thresholds, and the temperature information may comprise a measurement of the one or more electrical characteristics. The drug-dispensing device may further comprise a communication interface communicatively coupled with the processor, and the processor may be configured to generate the indication that the one or more temperature sensors have has been exposed to temperatures exceeding the first set of thresholds at least in part by wirelessly sending a message to a separate device via the communication interface. The processor may be configured to determine that the one or more temperature sensors have been exposed to temperatures exceeding the first set of thresholds at least in part by determining that the one or more temperature sensors have been exposed to temperatures outside a predetermined range of temperatures. The drug-dispensing device may further comprise a speaker, and the processor may be configured to generate the indication that the one or more temperature sensors have been exposed to temperatures exceeding the first set of thresholds at least in part by generating an audio alert using the speaker. The drug-dispensing device may further comprise an electrochromic element, and the processor may be configured to generate the indication that the one or more temperature sensors have been exposed to temperatures exceeding the first set of thresholds at least in part by generating a visual alert using the electrochromic element. The processor may be further configured to: obtain additional temperature information from the one or more temperature sensors, determine, based at least in part on the additional temperature information, that the one or more temperature sensors have been exposed to temperatures exceeding a second set of thresholds, and responsive to determining that one or more temperature sensors have been exposed to temperatures exceeding the second set of thresholds, generate an indication that the one or more temperature sensors have been exposed to temperatures exceeding the second set of thresholds. The processor may be further configured to, responsive to determining that the one or more temperature sensors have been exposed to temperatures exceeding first set of thresholds, prevent the drug-dispensing device from dispensing a drug. The one or more temperature sensors may comprise a temperature sensor located within a body of the drug-dispensing device adjacent to a cartridge containing a drug.

An example method of operating a drug-dispensing device, according to the description, comprises obtaining temperature information from one or more temperature sensors of the drug-dispensing device, determining, with a processor of the drug-dispensing device and based at least in part on the temperature information, that the one or more temperature sensors have been exposed to temperatures exceeding a first set of thresholds, and responsive to determining that the one or more temperature sensors have has been exposed to temperatures exceeding the first set of thresholds, generating an indication that the one or more temperature sensors have been exposed to temperatures exceeding the first set of thresholds.

Embodiments of the method may further comprise one or more the following features. The temperature information may comprise one or more temperature measurements taken by the one or more temperature sensors. The method may further comprise determining, with the processor and using the one or more temperature measurements and one or more previous temperature measurements, a length of time for which the one or more temperature sensors have been exposed to temperatures exceeding the first set of thresholds, comparing, with the processor, the length of time for which the one or more temperature sensors have been exposed to temperatures exceeding the first set of thresholds with a time threshold, and determining, with the processor, that the length of time for which the one or more temperature sensors have been exposed to temperatures exceeding the first set of thresholds has exceeded the time threshold. Generating The indication that the one or more temperature sensors have been exposed to temperatures exceeding the first set of thresholds may be additionally responsive to determining that the length of time for which the one or more temperature sensors have been exposed to temperatures exceeding the first set of thresholds has exceeded the time threshold. The one or more temperature sensors may be configured to undergo a change in one or more electrical characteristics when exposed to temperatures exceeding the first set of thresholds, and the temperature information comprises a measurement of the one or more electrical characteristics. Generating the indication that the one or more temperature sensors have has been exposed to temperatures exceeding the first set of thresholds may comprise sending a message from the drug-dispensing device to a separate device. Determining that the one or more temperature sensors have been exposed to temperatures exceeding the first set of thresholds may comprise determining that the one or more temperature sensors have been exposed to temperatures outside a predetermined range of temperatures. Generating the indication that the one or more temperature sensors have been exposed to temperatures exceeding the first set of thresholds may comprise generating an audio alert using a speaker of the drug-dispensing device. Generating the indication that the one or more temperature sensors have been exposed to temperatures exceeding the first set of thresholds may comprise generating a visual alert using a electrochromic element of the drug-dispensing device. The method may further comprise obtaining additional temperature information from the one or more temperature sensors, determining, based at least in part on the additional temperature information, that the one or more temperature sensors have been exposed to temperatures exceeding a second set of thresholds, and responsive to determining that one or more temperature sensors have been exposed to temperatures exceeding the second set of thresholds, generating an indication that the one or more temperature sensors have been exposed to temperatures exceeding the second set of thresholds. The method may further comprise, responsive to determining that the one or more temperature sensors have been exposed to temperatures exceeding first set of thresholds, preventing the drug-dispensing device from dispensing a drug. The one or more temperature sensors may comprise a temperature sensor located within a body of the drug-dispensing device adjacent to a cartridge containing a drug.

An example drug-dispensing device, according to the description, comprises sensing means configured to obtain temperature information, processing means configured to determine, based at least in part on the temperature information, that the sensing means has been exposed to temperatures exceeding a first set of thresholds, and indication means configured to generate an indication, responsive to determining that the sensing means has been exposed to temperatures exceeding a first set of thresholds, that the sensing means has been exposed to temperatures exceeding the first set of thresholds.

Embodiments of the drug-dispensing device may further comprise one or more of the following features. The temperature information may comprise one or more temperature measurements taken by the sensing means. The processing means may be configured to determine, using the one or more temperature measurements and one or more previous temperature measurements, a length of time for which the sensing means has been exposed to temperatures exceeding the first set of thresholds, compare the length of time for which the sensing means has been exposed to temperatures exceeding the first set of thresholds with a time threshold, and determine that the length of time for which the sensing means has been exposed to temperatures exceeding the first set of thresholds has exceeded the time threshold. The indication means maybe further configured to generate the indication that the sensing means has been exposed to temperatures exceeding the first set of thresholds additionally responsive to the determining that the length of time for which the sensing means has been exposed to temperatures exceeding the first set of thresholds has exceeded the time threshold. The sensing means may be configured to undergo a change in one or more electrical characteristics when exposed to temperatures exceeding the first set of thresholds, and the temperature information may comprise a measurement of the one or more electrical characteristics. The indication means may be configured to generate the indication that the sensing means has been exposed to temperatures exceeding the first set of thresholds at least in part by sending a message from the drug-dispensing device to a separate device. The processing means maybe configured to determine that the sensing means has been exposed to temperatures exceeding the first set of thresholds at least in part by determining that the sensing means have been exposed to temperatures outside a predetermined range of temperatures.

An example non-transitory computer-readable medium, according to the description, comprises instructions embedded thereon for operating a drug-dispensing device. The instructions comprise computer code for obtaining temperature information from one or more temperature sensors of the drug-dispensing device, determining, based at least in part on the temperature information, that the one or more temperature sensors have been exposed to temperatures exceeding a first set of thresholds, and responsive to determining that the one or more temperature sensors have has been exposed to temperatures exceeding the first set of thresholds, causing an indication that the one or more temperature sensors have been exposed to temperatures exceeding the first set of thresholds to be generated.

Embodiments of the non-transitory computer-readable medium may further comprise instructions with computer code for generating the indication that the one or more temperature sensors have has been exposed to temperatures exceeding the first set of thresholds further comprises computer code for sending a message from the drug-dispensing device to a separate device.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is an example system for providing information about the administration of medicine by a drug-dispensing device to one or more stakeholders.

FIG. 2 is an exploded view of an pen injector, according to an embodiment.

FIG. 3 is a cross-sectional view of a pen injector, according to an embodiment.

FIG. 4 is a block diagram illustrating the of components of a drug-dispensing device 110, according to an embodiment.

FIG. 5 is a state diagram illustrating how a drug-dispensing device can utilize temperature measurements from one or more temperature sensors, according to an embodiment.

FIG. 6 is a flow diagram illustrating a method of operating a drug-dispensing device, according to an embodiment.

### DETAILED DESCRIPTION

Several illustrative embodiments will now be described with respect to the accompanying drawings, which form a part hereof. The ensuing description provides embodiment(s) only, and is not intended to limit the scope, applicability or configuration of the disclosure. Rather, the ensuing description of the embodiment(s) will provide those skilled in the art with an enabling description for implementing an embodiment. It is understood that various changes may be made in the function and arrangement of elements without departing from the spirit and scope of this disclosure.

Drug-dispensing devices (e.g., injector pens, auto injectors, syringe needles, inhalers, pill dispensers, pill blister packs, etc.) can store and or dispense drugs to a patient in any of a variety of ways, such as via inhalation, injection, pill dispensing, etc. oftentimes these drugs may be stored and self-administered by the patient receiving the drugs.

Establishing that the right dose of the right drug is administered to the right patient at the right time via the right route can be important not only to the person taking the drug, but to many other entities as well. Other stakeholders that have an interest in this information include, for example, the doctor that prescribed and/or is overseeing the administration of the drug, a manufacturer of the drug, an insurance provider (and/or other payer), a government health agency and/or other health organization, and/or the like. For each of the stakeholders, the use and/or misuse of a drug may impact the decisions of a stakeholder with regard to the drug. For example, a drug that is consistently misused may impact whether or how an insurance provider is willing to pay for the use of the drug, and/or how to adjust premiums for patients that may consistently misuse drugs. It may also prompt a manufacturer to modify the means of administration of the drug to help reduce the misuse of its administration. All stakeholders may be impacted by use/misuse information in determining how effective a drug for a population of patients.

Embodiments disclosed herein help increase the likelihood of proper administration of a drug by using a temperature sensor to track temperatures to which the drug is exposed. Embodiments may further indicate to a user whether the drug has been exposed to temperatures outside of a suitable temperature range. This information can be used and/or combined with other information to help determine whether to dispense the drug and/or determine whether the drug has been administered properly. Additional details are provided herein below.

It can be noted that, although embodiments described herein often describe specific drug-dispensing devices, such as an injector pen or other injection device, embodiments are not so limited. Techniques utilizing temperature sensor to monitor temperatures to which the drug is exposed may be utilized in a variety of drug-dispensing devices and/or other devices which may or may not have medical applications.

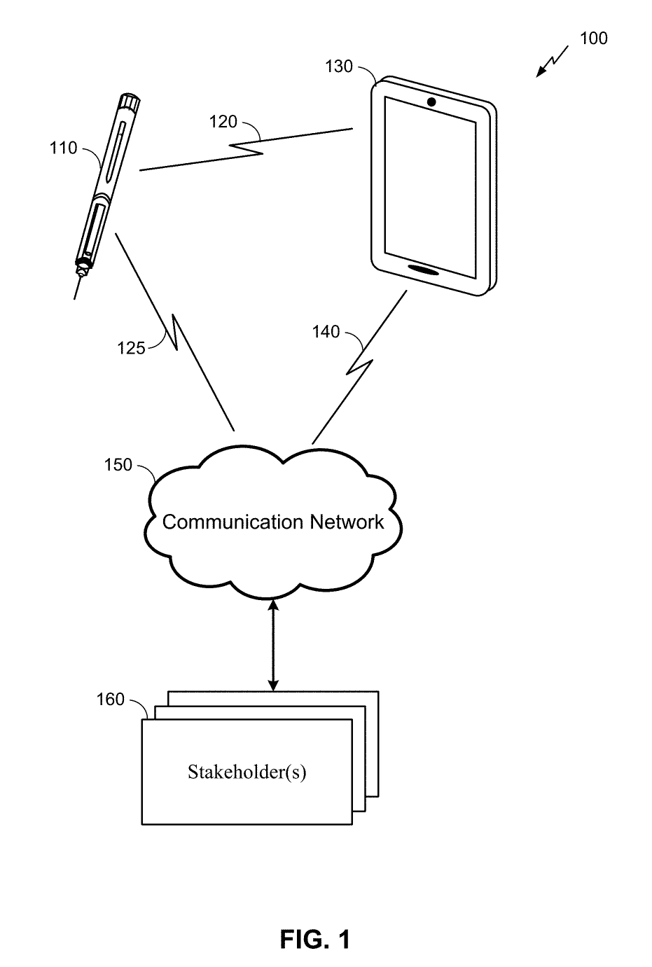

FIG. 1 is an example system 100 for providing information about the administration of medicine by a drug-dispensing device 110 to one or more stakeholders 160. Here, the system 100 may comprise the drug-dispensing device 110 as described herein, along with a connecting device 130, communication network 150, and the stakeholder(s) 160. It will be understood, however, that embodiments of a system 100 may include a different configuration of components, the addition and/or omission of various components, and/or the like, depending on desired functionality. Moreover, it will be understood that techniques described herein may be utilized in a drug-dispensing device 110 that may not necessarily be part of a larger system, such as the system 100 illustrated in FIG. 1.

The drug-dispensing device 110, which is described in more detail herein below, is used to administer a drug to a patient. Here, a person (e.g., a doctor, nurse, or patient him/herself) may administer the drug by engaging a physical mechanism to dispense the drug, in which case the drug-dispensing device 110 may positioned properly (e.g., an inhaler held to the patient's mouth, a needle inserted into the patient's skin, etc.). In some embodiments, once the drug is administered, the drug-dispensing device 110 can then register, store, and transmit data associated with the administration of the drug to the connecting device 130. This data can be transmitted wirelessly via a communication link 120, using any of a variety of wireless technologies as described in further detail below. That said, some embodiments may additionally or alternatively utilize wired communication.

The connecting device 130 may comprise any of a variety of electronic devices capable of receiving information from the drug-dispensing device 110 and communicating information to the stakeholder(s) 160 via the communication network 150. This can include, for example, a mobile phone, tablet, laptop, portable media player, personal computer, or similar device. In some embodiments, the connecting device 130 may comprise a specialized device utilized for purposes of conveying information from the drug-dispensing device 110 (and possibly other medical devices) to the stakeholder(s) 160. In some embodiments, the connecting device 130 may comprise a device owned and operated by the patient (e.g., the patient's mobile phone). In other embodiments, the connecting device 130 may be owned and/or operated by another entity, such as a healthcare provider, insurance company, government agency, etc.

The connecting device 130 may execute an application to provide the data processing and/or relaying functionality illustrated in FIG. 1. In some embodiments, the application may be configurable by a user, or may simply be downloaded to the connecting device 130 and executed automatically. The application may help establish the communication link 120 between the drug-dispensing device 110 and the connecting device 130, which may or may not require input from the user, depending on desired functionality. In some embodiments, the application may provide instructions to a user on proper use of the drug-dispensing device 110 and/or feedback to a user when improper use of the drug-dispensing device 110 is detected. Additional and/or alternative functionality of an application executed by the connecting device 130 may be utilized as desired. (Such functionality may include simple relaying of the data to a remote destination or interacting with the patient about the drug administration such as confirmation and user feedback.)

The communication network 150 may comprise any of a variety of data communication networks, depending on desired functionality. The communication network 150 can include any combination of radio frequency (RF), optical fiber, satellite, and/or other wireless and/or wired communication technologies. In some embodiments, the communication network 150 can comprise the Internet and/or different data networks may comprise various network types, including cellular networks, Wi-Fi® networks, etc. These types may include, for example, a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. An OFDMA network may employ LTE (including LTE category M (CatM) or 5G), LTE Advanced, and so on. LTE, LTE Advanced, GSM, and W-CDMA are described in documents from 3GPP. Cdma2000 is described in documents from a consortium named “3rd Generation Partnership Project 2” (3GPP2). 3GPP and 3GPP2 documents are publicly available. The communication network 150 may additionally or alternatively include a wireless local area network (WLAN), which may also be an IEEE 802.11x network, and a wireless personal area network (WPAN) may be a Bluetooth network, an IEEE 802.15x, Zigbee® network, and/or some other type of network. The techniques described herein may also be used for any combination of wireless wide area network (WWAN), WLAN and/or WPAN.

The communication link 140 between the connecting device 130 and the communication network 150 can vary, depending on the technologies utilized by these components of the system 100. For embodiments where the connecting device 130 is a mobile phone, for example, the communication link 140 may comprise a wireless communication link utilizing the mobile phone's cellular or Wi-Fi® functionality. In embodiments where the connecting device 130 is a personal computer, for example, the communication link 140 may comprise a wired communication link that accesses the communication network 150 via a cable or digital subscriber line (DSL) modem.

It can be noted that some embodiments may not utilize a connecting device 130 to relay data to the communication network 150. In such embodiments, the drug-dispensing device 110 may connect directly to the communication network 150 (as shown in FIG. 1 by communication link 125, which may be used in addition to or as an alternative to communication link 120). For example, the drug-dispensing device 110 may comprise a Long Term Evolution (LTE) category M (Cat-M) device, NarrowBand IoT (NB-IoT), or other Low Power Wide Area Network (LPWAN). Additionally or alternatively, the drug-dispensing device 110 may comprise wireless technology similar to the corresponding functionality of the connecting device 130 described above. In such embodiments, the communication network may additionally or alternatively comprise a Bluetooth Mesh network (such as CSRMesh), a WiFi network, Zigbee, or WWAN (such as LTE, including Cat-M, or 5G). In some embodiments, the drug-dispensing device 110 may connect both with the communication network 150 via communication link 125 and with the connecting device 130 the communication link 120. In such embodiments, the connecting device 130 may not need to separately communicate information regarding the drug-dispensing device 110 to stakeholders 160, but instead the drug-dispensing device 110 may communicate this information directly to the stakeholders 160 via the communication network 150.)

As noted above, the stakeholder(s) 160 may include any of a variety of entities with an interest in the proper administration of medicine by the drug-dispensing device 110. This can include an individual practitioner (e.g., a doctor or nurse), a hospital, a drug manufacturer, an insurance provider (or other payer), a government agency or other health organization, and/or the like. In some embodiments, the user of the drug-dispensing device 110 (e.g., the patient) may also be a stakeholder 160 to which information regarding the use of the drug-dispensing device 110 is provided. Governmental health regulations and/or legal agreements between the patient and/or the stakeholder(s) 160 may apply to the dissemination of information regarding the administration of a drug by the drug-dispensing device 110 to the stakeholder(s) 160. Here, as mentioned above and described in further detail below, the drug-dispensing device 110 can utilize a temperature sensor to help ensure the drug is dispensed correctly by the drug-dispensing device 110.

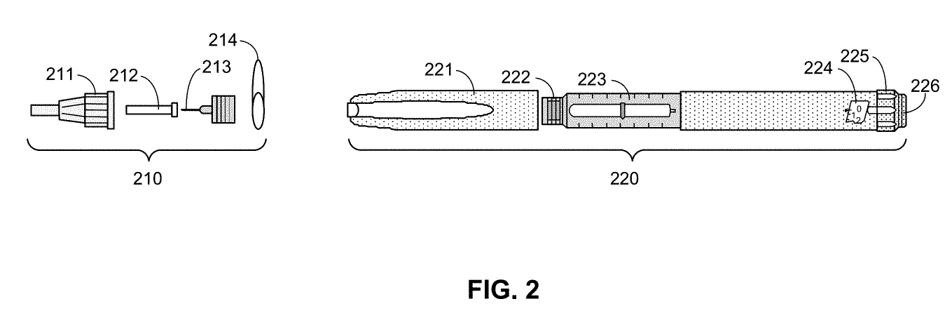

FIG. 2 is an exploded view of a needle assembly 210 and pen injector 220, according to an embodiment. Here, the pen injector 220 (and accompanying needle assembly 210) is a specific type of drug-dispensing device 110, although other types of drug-dispensing devices may have similar components. It will be understood, however, that various other types of drug-dispensing devices (e.g., auto injectors, syringe needles, inhalers, pill dispensers, pill blister packs, etc.) may be utilized in accordance with the techniques described herein, and that the pen injector 220 in FIG. 2, is provided simply as an example. Similarly, needle assemblies may also vary from the needle assembly 210 also illustrated in FIG. 2. Moreover, although the needle assembly 210 is illustrated as being separate from the pen injector 220, alternative embodiments of pen injectors or (more broadly) drug-dispensing devices 110 may comprise some or all of a needle assembly incorporated therein. It will also be understood that, in alternative embodiments, the various components of a needle assembly and the drug-dispensing device a may vary in size, shape, and/or other ways from the components of the needle assembly 210 and pen injector 220 illustrated in FIG. 2.

Here, the needle assembly 210 comprises an outer needle cap 211, an inner needle cap 212, a needle 213 (including a base, attachable to the pen injector 220), and a protective seal 214. Because the needle assembly 210 includes the needle 213 that is inserted into the skin of the patient, the needle assembly 210 is typically disposed of after use for sanitary purposes. Thus, a new needle assembly 210 may be used for each injection.

The pen injector 220 stores the drug to be administered and may be reused until the drug is depleted. Here, the pen injector 220 comprises a pen cap 221 that covers an attachment portion 222 to which the needle 213 may be coupled (e.g. by screwing the base of the needle to the attachment portion 222, using force to snap the needle 213 into place, and/or other attachment means). When the needle 213 is coupled to the pen injector 220, the pen cap 221 may be sufficiently large to protect the needle 213.

The pen injector 220 further comprises a reservoir 223 that holds a liquid drug. As described in further detail below, during administration, a piston (not shown) moves through the reservoir 223 to displace a volume of the drug, causing the drug to be dispensed through the needle 213 (when the needle 213 is properly coupled to the pen injector 220).

The pen injector 220 also includes a dosage window to 224 and dose selector 225, enabling a user to select a dose of the drug to be administered. The selection can be made by twisting the dose selector 225 (e.g., clockwise or counterclockwise) and selecting a desired dosage, which is shown through the dosage window 224.

Finally, the pen injector 220 includes an injection button 226. Once the needle 213 has been attached to the pen injector 220 and inserted into the skin of a patient, the drug may be administered by the patient (or other user) by pressing the injection button 226, causing a piston to move through the reservoir 223 as indicated above, and pushing a proper dosage of the drug through the needle for administration to the patient. The body of the pen injector 220 can further house various mechanical and/or electrical components (including a power source, such as a battery) configured to dispense the drug, determine the dose, determine temperatures to which the drug stored in the reservoir 223 has been exposed, communicate information to other devices, and/or perform other such functions as described herein.

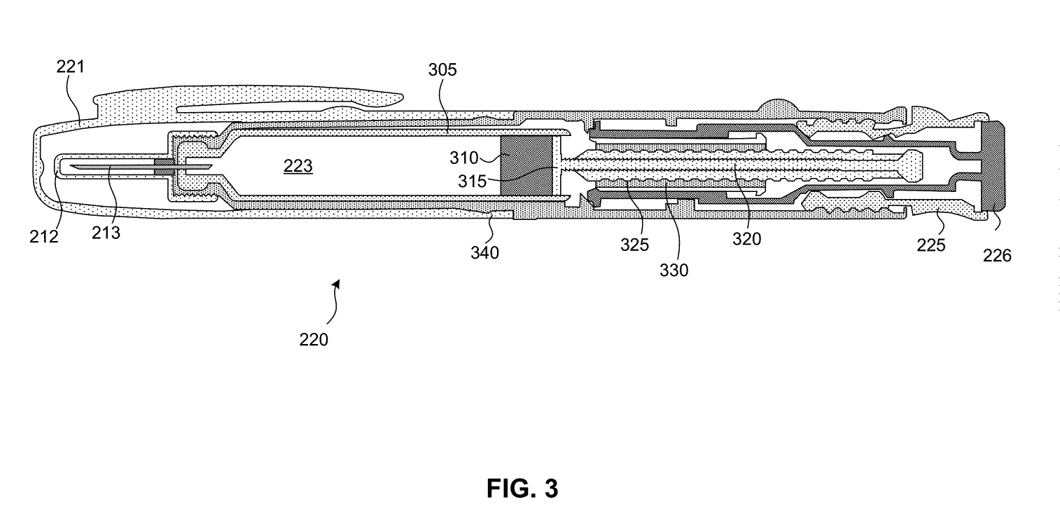

FIG. 3 is a cross-sectional view of a pen injector 220, according to an embodiment. Again, the pen injector 220 is a specific type of drug-dispensing device 110, although other types of drug-dispensing devices may have similar components. However, will also be understood that, in alternative embodiments, the various components of a needle assembly and the drug-dispensing device a may vary in size, shape, and/or other ways from the components of the pen injector 220 illustrated in FIG. 3. Moreover, although no electrical components are illustrated in FIG. 3, it will be understood that components of the pen injector 220 illustrated in FIG. 3 may be rearranged and/or modified to accommodate such electrical components and/or other components described herein below.

In the illustration in FIG. 3, some components illustrated in FIG. 2 are shown, including the pen cap 221, inner needle cap 212, needle 213, reservoir 223, and injection button 226. The pen injector further includes a cartridge 305 that stores the drug and comprises the reservoir 223. (In some embodiments, the cartridge may be replaceable, enabling the pen injector 220 to be used with multiple cartridges.) During the administration of the drug, a piston 310 is pushed by the head 315 of a drive stem 320, displacing the drug in the reservoir 223 to dispense the drug. The drive stem 320 may be screw driven, having threads 325 that feed the drive stem 320 through a nut 330. When the user presses the injection button 226, the movement of the drive stem 320 and piston 310, and corresponding volume of the drug in the reservoir 223 can be regulated by the dose selector 225.

Depending on desired functionality, one or more temperature sensors as described in more detail herein below, may be located within the pen injector 220 at any of a variety of locations. For example, in some embodiments, the temperature sensor may be located at or near the body 340 of the pen injector 220, to monitor and ambient temperature to which the pen injector 220 is exposed. Additionally or alternatively, a temperature sensor may be located near the cartridge 305, to more accurately determine the actual temperature of the drug. Additionally or alternatively, a temperature sensor may be coupled to the needle 213 and/or the temperature sensor may comprise a probe located within the pen injector 220 and configured to break the seal of the cartridge 305 in a manner similar to the needle 213, to be able to accurately determine a temperature of the drug stored in the reservoir 223.

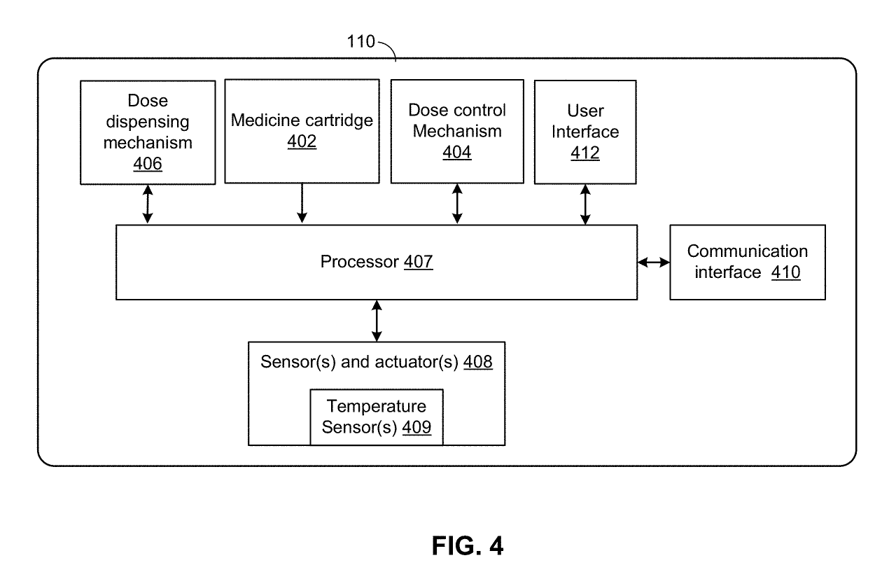

Again, the pen injector 220 illustrated in FIGS. 2-3 is provided as an example drug-dispensing device 110. Techniques for tracking temperature of the drug described herein may be applied to other types of drug-dispensing devices 110, including auto injectors, syringes, inhalers, and the like. A drug-dispensing device 110 may be described more generally as having various components is illustrated in FIG. 4.

FIG. 4 is a block diagram illustrating the configuration of components of a drug-dispensing device 110, according to an embodiment. The drug-dispensing device 110 can include a housing (not shown) structured to hold a medicine cartridge 402 (such as the cartridge 305 of the pen injector 220 illustrated in FIG. 3), and other components illustrated in FIG. 4. The medicine cartridge 402 may store the drug to be dispensed by the drug-dispensing device 110. The drug-dispensing device 110 can also include a dose control mechanism 404 to select or set a dose of the drug to be dispensed. The drug-dispensing device 110 further includes a dose dispensing mechanism 406 to dispense a dose of the drug, from medicine cartridge 402, based at least in part on the dose selected or set by dose control mechanism 404.

The drug-dispensing device 110 may include other devices to facilitate dispensing of medicine. In the example of FIG. 4, the drug-dispensing device 110 includes sensor(s) and actuator(s) 408, which may further comprise temperature sensor(s) 409, which may be utilized in embodiments described herein. Additionally, the drug-dispensing device 110 can include a processor 407 communicatively coupled with the sensor(s) and actuator(s) 408 and configured to, among other things, control the operations of the actuators based at least in part on the information collected by the sensor. For example, the sensors of sensor(s) and actuator(s) 408 can collect information of certain physical conditions at, for example, medicine cartridge 402, dose control mechanism 404, and dose dispensing mechanism 406. As such, the temperature sensors described herein may compose at least a portion of the sensor(s) and actuator(s) 408. Based at least in part on the collected information, the processor 407 can control the actuators of sensor(s) and actuator(s) 408 to change the operations of dose control mechanism 404 and/or dose dispensing mechanism 406. For example, based at least in part on one or more measurements of the temperature sensor(s) 409, the actuators can be controlled to change the operations of dose control mechanism 404 and/or dose dispensing mechanism 406 to prohibit administration of the drug and/or provide an indication to a user via the user interface 412 that the drug has been exposed to temperatures outside the suitable range for the drug.

The processor 407 may comprise without limitation one or more general-purpose processors, one or more special-purpose processors (such as digital signal processing (DSP) chips, graphics acceleration processors, application specific integrated circuits (ASICs), and/or the like), and/or other processing structure or means, which can be configured to perform one or more of the methods described herein. To help increase shelf life of the drug-dispensing device 110, the processing unit may be configured to operate in an extremely low power mode that, along with the capacity of a power supply (not shown), can allow the electrical components of the drug-dispensing device 110 to be used in after a substantially long time of no use. In some embodiments, the processor 407 may utilize additional hardware and/or software components (e.g., a memory) to provide the functionality described herein.

The user interface 412 may comprise one or more components configured to communicate information to a user, via audio, visual, or other means. For example, the user interface 412 may comprise an electrochromic element that can provide a visual indication of an error. Other visual indicators may comprise one or more light emitting diodes (LEDs), liquid crystal elements, and the like. The user interface 412 may further comprise an electrical speaker configured to provide audio communication. In some embodiments, once the determination that the drug has been exposed to a temperature range outside the suitable temperature range has been determined, the user interface 412 may provide an indication of this determination constantly (e.g., via an electrochromic element). Additionally or alternatively, the user interface 412 may provide this indication at certain times, such as when a user presses a button to dispense the drug. (The indication can then be provided for a certain period of time after the button is pressed.)

Moreover, the drug-dispensing device 110 may include a communication interface 410 which can communicate using wireless and/or wired means (e.g., via wireless link 120 and/or 125 of FIG. 1). Communication interface 410 may enable transmission of information related to administering the drug, including one or more measurements from a temperature sensor and/or an indication of whether the drug was administered properly. Additionally or alternatively, the drug-dispensing device 110 may communicate information related to a quantity of medicine to be dispensed, a quantity of medicine that has been dispensed, a quantity of medicine remaining in medicine cartridge 402, etc. The information can then be displayed to the user via a user interface, to assist the user in administering of the medicine.

The temperature sensor(s) 409 can be utilized in any of a variety of ways. For example, in some embodiments, there may be multiple thresholds that define a range (e.g. an upper threshold and a lower threshold) of suitable temperatures at which I drug can be stored. In some embodiments, there might be a first set of thresholds that establish a “warning” range, at which a drug dispensing device may inform the user that the drug is exposed to temperatures near (e.g., within 1°, 3°, 5°, etc., depending on desired functionality) a limit at which the drug may be safely stored. This limit may be established by a second set of thresholds. And when the second set of thresholds is exceeded, the drug-dispensing device may send an alert to the user and prevent administration of the drug thereafter.

In addition, the device may be able to measure time at temperature to make a determination as to the safety and effectiveness of the drug as being so exposed. After this determination is made, it may be communicated through the communications system, or displayed via electrochromic element or similar indicator. Determining a length of time at which the drug is exposed to a temperature can be used in any of a variety of ways, because length of time a drug is exposed to certain temperatures can have different effects. Exceeding a temperature threshold for one minute, for example, may have a much smaller effect then exceeding a temperature threshold for one day. As such, warnings and/or alerts described herein can further be based on a time threshold. Additionally or alternatively, a different weightings or combinations of temperature and time may be used to provide different alerts.

In some embodiments, a drug-dispensing device 110 may be capable of dispensing different types of drugs (e.g., by using removable cartridges that may contain any of a variety of drugs). In such cases, the different types of drugs may have different thresholds (e.g., the suitable ranges at which these drugs may be stored may vary from drug to drug). In such embodiments, when a new drug (e.g., cartridge) is placed in the drug-dispensing device, the drug-dispensing device 110 may obtain the thresholds for that particular drug. In some embodiments, for example, a user may input the type of drug into a separate device (e.g., a connecting device 130) communicatively connected with the drug-dispensing device 110. The separate device may then send information regarding the new drug to the drug-dispensing device 110. This information may comprise the type of drug, in which case the drug-dispensing device 110 may use that information to obtain from local memory (e.g., in a lookup table) applicable thresholds for that particular drug. Additionally or alternatively, the separate device may send the applicable to the drug-dispensing device 110. In some embodiments, the drug-dispensing device 110 may comprise input means (e.g. a switch, dial, touchpad, etc.) for enabling a user to input the type of drug, in which case the drug-dispensing device 110 may obtain the thresholds from a local memory. A person of ordinary skill in the art will appreciate other variations.

In some embodiments, the sensor(s) and actuator(s) 408 may comprise an actuator responsive to a pre-set temperature. In such embodiments, upon reaching that pre-set temperature, a physical change may occur in the actuator such that it sets a latch or other mechanism to disable means for dispensing medicine. For example, in some embodiments of a drug-dispensing device 110, an actuator may comprise a bimetallic “popper” plate or disk that, upon reaching a threshold temperature, “pops,” or changes from a flat to a cupped shape. This can push a mechanical latch or drive some other locking mechanism to disable the drug-dispensing capability of the drug-dispensing device 110. In some embodiments, actuator may not only drive the locking mechanism, but can also drive a mechanical indicator on the drug delivery device to help the user understand why the device is a functioning. For example, the actuator may cause a colored pin to pops out of place or cause some other component to move in a similar fashion.

Such physical actuators could be used for a maximum temperature threshold (e.g., 86° F. for insulin) for a minimum temperature threshold (e.g., 32° F. for insulin). As such, to actuators could be used in combination to establish an allowable range with a maximum temperature threshold and a minimum temperature threshold.

According to some embodiments, a temperature sensor may comprise a temperature-dependent component that, when exposed to temperatures that exceed a threshold, experiences a permanent (or long-term) change in one or more electrical characteristics (resistance, capacitance, etc.). In such embodiments, a detection circuit may then only need to make a single measurement of the electrical characteristic of the temperature sensor prior to the desired distribution of the drug, rather than periodically sampling the temperature sensor, thereby resulting in potentially significant power savings. For example, embodiments may utilize a one or more devices that serve as a “fuse” that blows when exposed to a certain maximum and/or minimum temperature. In such embodiments, there may be no need to monitor the temperatures before the first usage. However, prior to each use, detection circuitry can measure the temperature-dependent component to see if its electrical characteristic (e.g. resistance) indicates a temperature threshold was exceeded, at which point the drug-dispensing device can prohibit drug administration and/or provide an indication to a user that the temperature threshold was exceeded and the drug has been compromised.

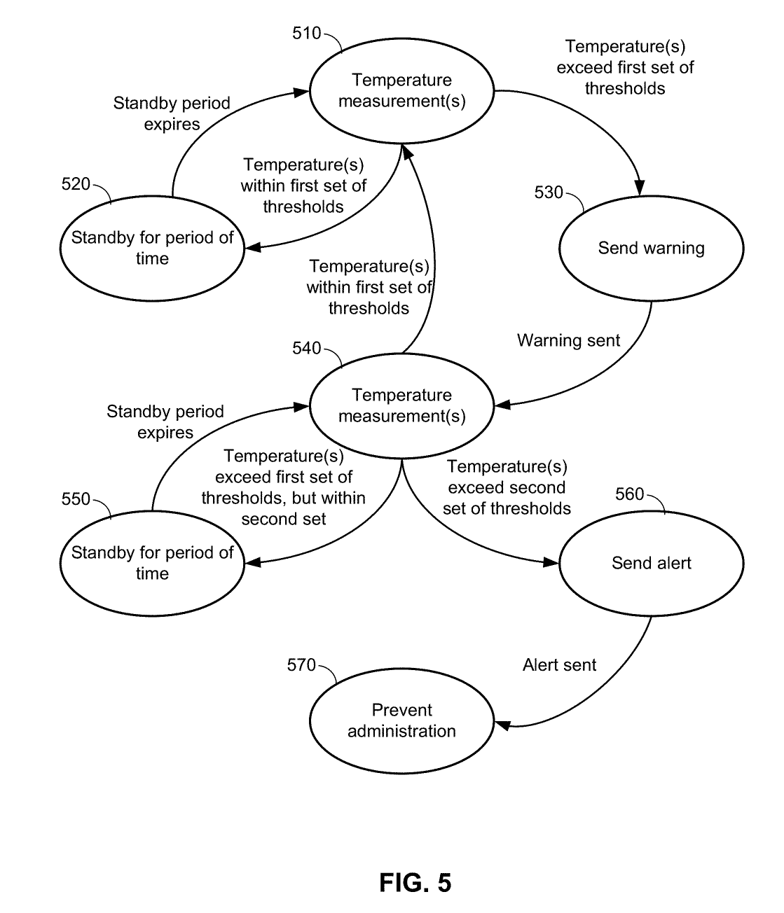

FIG. 5 is a state diagram illustrating how a drug-dispensing device can utilize temperature measurements from one or more temperature sensors, according to an embodiment. In this particular embodiment, the drug-dispensing device can issue both a warning that the drug is being exposed to temperatures a limit for the drug and an alert that the drug has been exposed to temperatures outside the limit for the drug. As such, this embodiment utilizes two sets of thresholds. However, it will be understood that alternative embodiments may utilize more or fewer sets of thresholds. Moreover, it will further be understood that a “set” of thresholds may comprise a single threshold (e.g., an upper temperature limit or a lower temperature limit), or multiple thresholds (e.g., both an upper temperature limit and a lower temperature limit), depending on desired functionally. It can be appreciated that the limits may include temperature and time elements and combinations thereof.

The process can begin at state 510, where one or more temperature measurements are taken. As indicated above, a drug-dispensing device may comprise one or more temperature sensors, which may be distributed at various locations within the drug-dispensing device, and each of which may be capable of taking an independent measurement of temperature. The temperature measurement(s) may be compared with a first set of thresholds that may establish a first upper and/or lower temperature threshold, which, if exceeded, will cause the device to send a warning to the user.

The first set of thresholds may be set a few degrees from the maximum and/or minimum temperatures to which the drug may be exposed. This can enable the drug-dispensing device to provide a warning at some time prior to when the drug has been exposed to a temperature exceeding an upper or lower limit, allowing a user to take corrective actions before the drug is no longer usable. (In alternative embodiments a timer may be used in addition or as an alternative to the first set of thresholds so that, if the drug is exposed to a certain temperature for a certain period of time, the drug-dispensing device can send and alert and prevent administration of the drug.) For example, if a suitable range of temperatures for a drug is between 15° C. and 25° C., the first set of thresholds may establish a lower threshold of 17° C. and an upper threshold of 23° C.

If the temperature(s) measured in state 510 are within the first set of thresholds, the process can move to state 520, where the drug-dispensing device can enter a standby state for a period of time. Such functionality can enable the drug-dispensing device to save power, which may be particularly useful in cases where a battery of the drug-dispensing devices somewhat limited in capacity. For example, in state 520, a processing unit of the drug-dispensing device (e.g., processor 407 of FIG. 4) may enter a low-power or “sleep” mode for a certain period of time, and exiting the low-power or “sleep” mode only when the standby period expires. The length of the standby period (e.g., the time in which the drug-dispensing device is in state 520) can vary, depending on desired functionality. In some embodiments, this period may be relatively short (e.g., every few seconds) or relatively long (e.g., every few minutes). In some embodiments, this period of time may vary, depending on previous temperature measurements. Once the standby period expires, the drug-dispensing device returns to state 510 and takes one or more temperature measurements.

If the temperature measurements are outside the first set of thresholds (e.g., above an upper threshold or below a lower threshold set by the first set of thresholds) than the drug-dispensing device moves to state 530, where it sends a warning. Depending on desired functionality, the warning may be sent in any of a variety of ways. In some embodiments, the drug-dispensing device may send a signal to a connected device (e.g., a user's mobile phone), which can provide an audio or visual warning to a user. Additionally or alternatively, the warning may be provided directly to the user by the drug-dispensing device, in the form of an audio or visual warning given by the drug-dispensing device itself. In some embodiments, a warning may be sent to one or more stakeholders (e.g., a healthcare provider, caretaker, insurance company, etc.) other than the user. (After the warning is sent at state 530, the drug-dispensing device may enter a standby period for a certain amount of time before taking one or more additional temperature measurements at state 540.)

The drug-dispensing device then moves to state 540 where one or more additional temperature measurements are taken. If the one or more additional temperature measurements indicate that temperatures no longer exceed the first set of thresholds, then the drug-dispensing device can return to state 510. If the one or more additional temperature measurements indicate that temperatures remain outside the first set of thresholds, but are below a second set of thresholds, then the drug-dispensing device can move to state 550, where it again enters a standby mode for a certain period of time (similar to state 520). Again, once the standby period expires, the drug-dispensing device can return to state 540. Here, the second set of thresholds may establish the maximum and/or minimum temperature to which the drug may be exposed. Thus, if a drug is not to be exposed to temperatures lower than 15° C. or higher than 25° C., the second set of thresholds may establish a minimum threshold of 15° C. and/or a maximum threshold of 25° C.

If the temperature(s) measured at state 540 exceed the second set of thresholds, then the effectiveness of the drug may be compromised and the drug-dispensing device can take measurements to ensure it is not used. Thus, the drug-dispensing device can move to state 560, where it sends an alert. Similar to the warning sent at state 530, the alert sent at state 560 may be sent to a user and/or other stakeholder, and may comprise an audio or visual alert.

Once the alert is sent, the drug-dispensing device can move to state 570, where the drug-dispensing device can prevent administration of the drug. Here, the drug-dispensing device may employ mechanical and/or electrical safeguards to prevent administration of the drug by the drug-dispensing device. The drug-dispensing device may remain in this state until it determines (e.g., using sensors, user input, and/or other data) that the compromised drug has been removed from the drug-dispensing device.

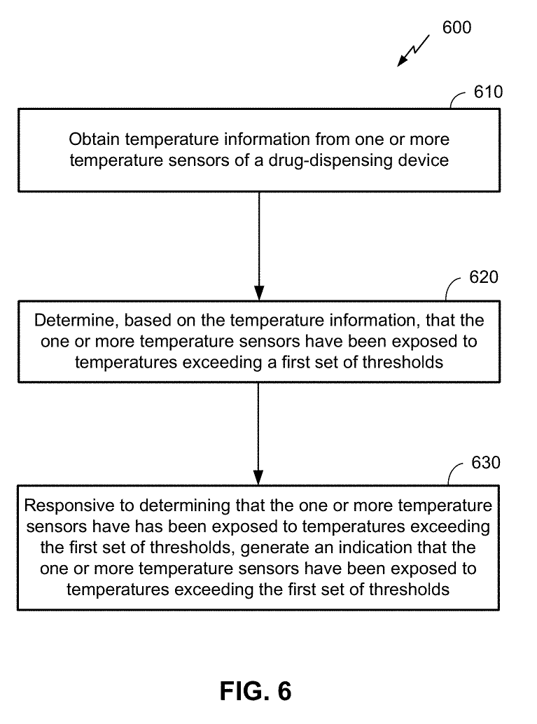

FIG. 6 is a flow diagram illustrating a method 600 of operating a drug-dispensing device, according to an embodiment. It can be noted that, as with figures appended hereto, FIG. 6 is provided as a non-limiting example. Other embodiments may vary, depending on desired functionality. For example, the functional blocks illustrated in method 600 may be combined, separated, or rearranged to accommodate different embodiments. The method 600 may be performed by a drug-dispensing device. Means for performing the functionality of method 600 may therefore include one or more components of the drug-dispensing device 110 described in the embodiments above, including hardware and/or software components, as illustrated in FIG. 4 above. Hardware components may include analog and/or digital circuitry, including a processor (e.g., processor 407 of FIG. 4). A person of ordinary skill in the art will appreciate the various means by which the functions in method 600 may be performed.

At block 610, temperature information is obtained from one or more temperature sensors of a drug-dispensing device. Depending on where the one or more temperature sensors are located within the drug-dispensing device, the temperature information therefore may be indicative of temperatures to which a drug housed by the drug-dispensing device is exposed. In some embodiments, the one or more temperature sensors may comprise a temperature sensor located within a body of the drug-dispensing device adjacent to a cartridge, container, or other compartment containing the drug. Means for performing the functionality at block 610 may comprise sensor(s) and actuator(s) 408 (including temperature sensor(s) 409), processor 407, and/or other components of a drug-dispensing device 110 as illustrated in FIG. 4 and described above.

At block 620, the functionality comprises determining, based at least in part on the temperature information, that the one or more temperature sensors have been exposed to temperatures exceeding a first set of thresholds. Here, the first set of thresholds may include maximum and/or minimum temperature thresholds, and may reflect maximum or minimum temperatures to which the drug can be exposed, or “warning” thresholds that indicate these maximum or minimum temperatures are being approached. As such, determining that the one or more temperature sensors have been exposed to temperatures exceeding the first set of thresholds may further comprise determining that the one or more temperature sensors have been exposed to a temperature outside a predetermined range of temperatures. Means for performing the functionality at block 610 may comprise the processor 407 and/or other components of a drug-dispensing device 110 as illustrated in FIG. 4 and described above.

At block 630, the functionality includes, responsive to determining that the one or more temperature sensors have been exposed to temperatures exceeding the first set of thresholds, generating an indication that the one or more temperature sensors have been exposed to temperatures exceeding the first set of thresholds. This indication can vary, depending on desired functionality. For example, in some embodiments the drug-dispensing device may comprise a communication interface, in which case generating the indication that the one or more temperature sensors have been exposed to temperatures exceeding the first set of thresholds may comprise wirelessly sending a message to a separate device via the communication interface. This can enable the separate device (e.g. a mobile phone or other connected device) to provide information to a user or other stakeholder that temperatures have exceeded the first set of thresholds. The drug-dispensing device may comprise a speaker, in which case generating the indication that the one or more temperature sensors have been exposed to temperatures exceeding the first set of thresholds may comprise generating an audio alert using the speaker. Additionally or alternatively, the drug-dispensing device make comprise an electrochromic element, in which case generating the indication that the one or more temperature sensors have been exposed to temperatures exceeding the first set of thresholds may comprise generating a visual alert using the electrochromic element. Means for performing the functionality at block 610 may comprise sensor(s) and actuator(s) 408, processor 407, user interface 412, and/or other components of a drug-dispensing device 110 as illustrated in FIG. 4 and described above.

The method 600 may further comprise additional functionality, depending on the functionality desired. For instance, as noted previously, the first set of thresholds may comprise a thresholds used to provide a warning that the temperature of the drug may be approaching a maximum or minimum temperature to which the drug can be safely exposed. In such instances, a second set of thresholds may be used to represent the these maximum and/or minimum temperatures. In such instances, for example, the method 600 may further comprise obtaining additional temperature information from the one or more temperature sensors, determining, based at least in part on the additional temperature information, that the one or more temperature sensors have been exposed to temperatures exceeding a second set of thresholds, and, responsive to determining that the one or more temperature sensors have been exposed to temperatures exceeding the second set of thresholds, generating an indication that the one or more temperature sensors have been exposed to temperatures exceeding the second set of thresholds.

In some embodiments, the drug-dispensing device may have a dose-dispensing mechanism that can be physically and/or electrically locked to prevent the drug-dispensing device from dispensing the drug. In such instances, the method 600 may further comprise, responsive to determining that the one or more temperature sensors have been exposed to temperatures exceeding the first set of thresholds, preventing the drug-dispensing device from dispensing a drug.

Some drugs may still be safe to use even after being exposed to a temperature outside a maximum or minimum temperature range. However, they may become unsafe to use after being exposed to temperatures outside that acceptable temperature range for a threshold amount of time. Thus, embodiments of the method 600 may further comprise determining, using the one or more temperature measurements (for embodiments in which the one or more temperature sensors provide one or more temperature measurements) and one or more previous temperature measurements, a length of time for which the one or more temperature sensors have been exposed to temperatures exceeding the first set of thresholds. The length of time for which the one or more temperature sensors have been exposed to temperatures exceeding the first set of thresholds is then compared with a time threshold. It can then be determined that the length of time for which the one or more temperature sensors have been exposed to temperatures exceeding the first set of thresholds has exceeded the time threshold. If such is the case, indicating, at block 630, that the one or more temperature sensors have been exposed to temperatures exceeding the first set of thresholds may additionally be responsive to the determination that the length of time for which the one or more temperature sensors have been exposed to temperatures exceeding the first set of thresholds has exceeded the time threshold.

The temperature information may vary, depending on the type of one or more temperature sensors used. For example, in some embodiments, one or more temperature sensors are configured to undergo a change in the one or more electrical characteristics (e.g., a change in electrical resistance) when exposed to temperatures exceeding the first set of thresholds. In such embodiments, the temperature information may comprise a measurement of the one or more electrical characteristics (e.g., a measurement of electrical eating resistance). Additionally or alternatively, the one or more temperature sensors may be configured to take one or more temperature measurements. In such embodiments, the temperature information may therefore comprise the one or more temperature measurements.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that may comprise memory may comprise non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

Therefore, it is intended that claimed subject matter not be limited to the particular examples disclosed, but that such claimed subject matter may also include all aspects falling within the scope of appended claims, and equivalents thereof.

What is claimed is:

1. A drug-dispensing device comprising:
one or more temperature sensors; and
a processor communicatively coupled with the one or more temperature sensors and configured to:
obtain temperature information from the one or more temperature sensors;
determine, based at least in part on the temperature information, that the one or more temperature sensors have been exposed to temperatures exceeding a first set of thresholds; and
responsive to determining that the one or more temperature sensors have been exposed to temperatures exceeding the first set of thresholds, generate an indication that the one or more temperature sensors have been exposed to temperatures exceeding the first set of thresholds.

2. The drug-dispensing device of claim 1, wherein:
the one or more temperature sensors are configured to take one or more temperature measurements, and
the temperature information comprises the one or more temperature measurements.

3. The drug-dispensing device of claim 2, wherein the processor is further configured to:
determine, using the one or more temperature measurements and one or more previous temperature measurements, a length of time for which the one or more temperature sensors have been exposed to temperatures exceeding the first set of thresholds;
compare the length of time for which the one or more temperature sensors have been exposed to temperatures exceeding the first set of thresholds with a time threshold; and
determine that the length of time for which the one or more temperature sensors have been exposed to temperatures exceeding the first set of thresholds has exceeded the time threshold;
wherein the processor is configured to generate the indication that the one or more temperature sensors have been exposed to temperatures exceeding the first set of thresholds additionally responsive to determining that the length of time for which the one or more temperature sensors have been exposed to temperatures exceeding the first set of thresholds has exceeded the time threshold.

4. The drug-dispensing device of claim 1, wherein:
the one or more temperature sensors are configured to undergo a change in one or more electrical characteristics when exposed to temperatures exceeding the first set of thresholds, and
the temperature information comprises a measurement of the one or more electrical characteristics.

5. The drug-dispensing device of claim 1, further comprising a communication interface communicatively coupled with the processor, wherein the processor is configured to generate the indication that the one or more temperature sensors have has been exposed to temperatures exceeding the first set of thresholds at least in part by wirelessly sending a message to a separate device via the communication interface.

6. The drug-dispensing device of claim 1, wherein the processor is configured to determine that the one or more temperature sensors have been exposed to temperatures exceeding the first set of thresholds at least in part by determining that the one or more temperature sensors have been exposed to temperatures outside a predetermined range of temperatures.

7. The drug-dispensing device of claim 1, further comprising a speaker, wherein the processor is configured to generate the indication that the one or more temperature sensors have been exposed to temperatures exceeding the first set of thresholds at least in part by generating an audio alert using the speaker.

8. The drug-dispensing device of claim 1, further comprising an electrochromic element, wherein the processor is configured to generate the indication that the one or more temperature sensors have been exposed to temperatures exceeding the first set of thresholds at least in part by generating a visual alert using the electrochromic element.

9. The drug-dispensing device of claim 1, wherein the processor is further configured to:
obtain additional temperature information from the one or more temperature sensors;
determine, based at least in part on the additional temperature information, that the one or more temperature sensors have been exposed to temperatures exceeding a second set of thresholds; and
responsive to determining that one or more temperature sensors have been exposed to temperatures exceeding the second set of thresholds, generate an indication that the one or more temperature sensors have been exposed to temperatures exceeding the second set of thresholds.

10. The drug-dispensing device of claim 1, wherein the processor is further configured to, responsive to determining that the one or more temperature sensors have been exposed to temperatures exceeding first set of thresholds, prevent the drug-dispensing device from dispensing a drug.

11. The drug-dispensing device of claim 1, wherein the one or more temperature sensors comprise a temperature sensor located within a body of the drug-dispensing device adjacent to a cartridge containing a drug.

12. A method of operating a drug-dispensing device comprising:
obtaining temperature information from one or more temperature sensors of the drug-dispensing device;
determining, with a processor of the drug-dispensing device and based at least in part on the temperature information, that the one or more temperature sensors have been exposed to temperatures exceeding a first set of thresholds; and
responsive to determining that the one or more temperature sensors have has been exposed to temperatures exceeding the first set of thresholds, generating an indication that the one or more temperature sensors have been exposed to temperatures exceeding the first set of thresholds.

13. The method of claim 12, wherein the temperature information comprises one or more temperature measurements taken by the one or more temperature sensors.

14. The method of claim 13, further comprising:
determining, with the processor and using the one or more temperature measurements and one or more previous temperature measurements, a length of time for which the one or more temperature sensors have been exposed to temperatures exceeding the first set of thresholds;
comparing, with the processor, the length of time for which the one or more temperature sensors have been exposed to temperatures exceeding the first set of thresholds with a time threshold; and
determining, with the processor, that the length of time for which the one or more temperature sensors have been exposed to temperatures exceeding the first set of thresholds has exceeded the time threshold;
wherein generating the indication that the one or more temperature sensors have been exposed to temperatures exceeding the first set of thresholds is additionally responsive to determining that the length of time for which the one or more temperature sensors have been exposed to temperatures exceeding the first set of thresholds has exceeded the time threshold.

15. The method of claim 12, wherein:
the one or more temperature sensors are configured to undergo a change in one or more electrical characteristics when exposed to temperatures exceeding the first set of thresholds; and
the temperature information comprises a measurement of the one or more electrical characteristics.

16. The method of claim 12, wherein generating the indication that the one or more temperature sensors have has been exposed to temperatures exceeding the first set of thresholds comprises sending a message from the drug-dispensing device to a separate device.

17. The method of claim 12, wherein determining that the one or more temperature sensors have been exposed to temperatures exceeding the first set of thresholds comprises determining that the one or more temperature sensors have been exposed to temperatures outside a predetermined range of temperatures.

18. The method of claim 12, wherein generating the indication that the one or more temperature sensors have been exposed to temperatures exceeding the first set of thresholds comprises generating an audio alert using a speaker of the drug-dispensing device.

19. The method of claim 12, wherein generating the indication that the one or more temperature sensors have been exposed to temperatures exceeding the first set of thresholds comprises generating a visual alert using a electrochromic element of the drug-dispensing device.

20. The method of claim 12, further comprising:
obtaining additional temperature information from the one or more temperature sensors;
determining, based at least in part on the additional temperature information, that the one or more temperature sensors have been exposed to temperatures exceeding a second set of thresholds; and
responsive to determining that one or more temperature sensors have been exposed to temperatures exceeding the second set of thresholds, generating an indication that the one or more temperature sensors have been exposed to temperatures exceeding the second set of thresholds.

21. The method of claim 12, further comprising, responsive to determining that the one or more temperature sensors have been exposed to temperatures exceeding first set of thresholds, preventing the drug-dispensing device from dispensing a drug.

22. The method of claim 12, wherein the one or more temperature sensors comprise a temperature sensor located within a body of the drug-dispensing device adjacent to a cartridge containing a drug.

23. A drug-dispensing device comprising:
sensing means configured to obtain temperature information;
processing means configured to determine, based at least in part on the temperature information, that the sensing means has been exposed to temperatures exceeding a first set of thresholds; and
indication means configured to generate an indication, responsive to determining that the sensing means has been exposed to temperatures exceeding a first set of thresholds, that the sensing means has been exposed to temperatures exceeding the first set of thresholds.

24. The drug-dispensing device of claim 23, wherein the temperature information comprises one or more temperature measurements taken by the sensing means.

25. The drug-dispensing device of claim 24, wherein the processing means is configured to:
determine, using the one or more temperature measurements and one or more previous temperature measurements, a length of time for which the sensing means has been exposed to temperatures exceeding the first set of thresholds;
compare the length of time for which the sensing means has been exposed to temperatures exceeding the first set of thresholds with a time threshold; and
determine that the length of time for which the sensing means has been exposed to temperatures exceeding the first set of thresholds has exceeded the time threshold;
wherein the indication means is further configured to generate the indication that the sensing means has been exposed to temperatures exceeding the first set of thresholds additionally responsive to the determining that the length of time for which the sensing means has been exposed to temperatures exceeding the first set of thresholds has exceeded the time threshold.

26. The drug-dispensing device of claim 23, wherein:
the sensing means is configured to undergo a change in one or more electrical characteristics when exposed to temperatures exceeding the first set of thresholds, and
the temperature information comprises a measurement of the one or more electrical characteristics.

27. The drug-dispensing device of claim 23, wherein the indication means is configured to generate the indication that the sensing means has been exposed to temperatures exceeding the first set of thresholds at least in part by sending a message from the drug-dispensing device to a separate device.

28. The drug-dispensing device of claim 23, wherein the processing means is configured to determine that the sensing means has been exposed to temperatures exceeding the first set of thresholds at least in part by determining that the sensing means have been exposed to temperatures outside a predetermined range of temperatures.

29. A non-transitory computer-readable medium having instructions embedded thereon for operating a drug-dispensing device, the instructions comprising computer code for:
obtaining temperature information from one or more temperature sensors of the drug-dispensing device;
determining, based at least in part on the temperature information, that the one or more temperature sensors have been exposed to temperatures exceeding a first set of thresholds; and
responsive to determining that the one or more temperature sensors have has been exposed to temperatures exceeding the first set of thresholds, causing an indication that the one or more temperature sensors have been exposed to temperatures exceeding the first set of thresholds to be generated.

30. The non-transitory computer-readable medium of claim 29, wherein the computer code for generating the indication that the one or more temperature sensors have has been exposed to temperatures exceeding the first set of thresholds further comprises computer code for sending a message from the drug-dispensing device to a separate device.
